(19) United States
(12) Patent Application Publication
(10) Pub. No.: US 2026/0368220 A1
(43) Pub. Date: Nov. 19, 2026

(54) DECOMPOSITION OF COMPLEX QUERIES

(71) Applicant: International Business Machines Corporation, Armonk, NY (US)

(72) Inventors: Donald Banks, Ottawa (CA); Obidul Islam, Kanata (CA); Sagar Thomas, Mississauga (CA); Zhibo Zhang, Ottawa (CA)

(21) Appl. No.: 19/209,565

(22) Filed: May 15, 2025

(51) Int. Cl. G06F 16/3332; G06F 16/332; G06F 16/35

(52) U.S. Cl. CPC G06F 16/3332; G06F 16/332; G06F 16/35

(57) ABSTRACT

A method, according to one approach, includes: receiving a natural language query and classifying the natural language query into a category. The natural language query is rephrased into a refined natural language query. A query language input is also generated by converting the refined natural language query into a query language. Targeted data locations that the query language input references are determined. Statistics associated with the targeted data locations are analyzed. Furthermore, the query language input is modified to generate a refined query language input based at least in part on the analyzed statistics.

### BACKGROUND

The present invention relates to queries, and more specifically, this invention relates to satisfying user queries.

The continued advancement of intelligent interaction has increased the prevalence of natural language inputs. These natural language inputs allow for non-technical end users the opportunity to submit queries and receive answers which provide insight into underlying data. Moreover, this may be done without detailed knowledge of exactly how the data is stored or how an answer to their submitted query may be determined.

Text to SQL has been developed in an attempt to apply natural language processing (NLP) and potentially large language models (LLMs) to map queries to known data. For example, text to SQL may return the tables and/or columns of a relational database for the purposes of data retrieval. While this has allowed conventional products to respond to queries that call for simple data retrievals, these conventional products have been unable to field queries that call for processing (e.g., evaluation) of stored data.

### SUMMARY

A method, according to one approach, includes: receiving a natural language query and classifying the natural language query into a category. The natural language query is rephrased into a refined natural language query. A query language input is also generated by converting the refined natural language query into a query language. Targeted data locations that the query language input references are determined. Statistics associated with the targeted data locations are analyzed. Furthermore, the query language input is modified to generate a refined query language input based at least in part on the analyzed statistics.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for performing question decomposition of complex questions that go beyond the Text to SQL use-case. Approaches herein may thereby be able to efficiently and accurately generate answers to questions that cannot be directly queried from any existing data. This has not been conventionally achievable. Approaches herein thereby have a significant impact on efficiency of the system overall, e.g., as will be described in further detail below.

In one general approach, a method includes: receiving a natural language query and classifying the natural language query into a category. The natural language query is rephrased into a refined natural language query. A query language input is also generated by converting the refined natural language query into a query language. Targeted data locations that the query language input references are determined. Statistics associated with the targeted data locations are analyzed. Furthermore, the query language input is modified to generate a refined query language input based at least in part on the analyzed statistics.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved query response code 150 for performing question decomposition of complex questions that go beyond the Text to SQL use-case. Approaches herein may thereby be able to efficiently and accurately generate answers to questions that cannot be directly queried from any existing data. This has not been conventionally achievable. Approaches herein thereby have a significant impact on efficiency of the system overall, e.g., as will be described in further detail below.

In addition to code 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and code 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

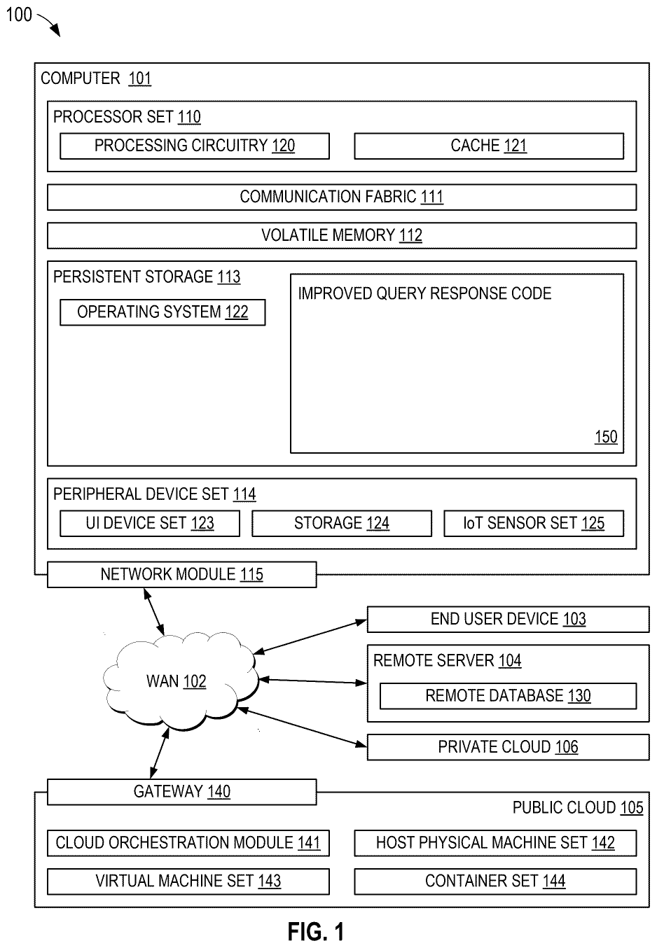

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, the continued advancement of intelligent interaction has increased the prevalence of natural language inputs. These natural language inputs allow for non-technical end users the opportunity to submit queries and receive answers which provide insight into underlying data. Moreover, this may be done without detailed knowledge of exactly how the data is stored or how an answer to their submitted query may be determined.

Text to SQL has been developed in an attempt to apply natural language processing (NLP) and potentially large language models (LLMs) to map queries to known data. For example, text to SQL may return the tables and/or columns of a relational database for the purposes of data retrieval. While this has allowed conventional products to respond to queries that call for simple data retrievals, these conventional products have been unable to field queries that call for processing (e.g., evaluation) of stored data.

In sharp contrast to the foregoing shortcomings experienced in conventional products, approaches herein are able to perform question decomposition for questions that go beyond the Text to SQL use-case. Approaches herein are thereby able to process received queries (used interchangeably herein with “questions”) regardless of the level of abstraction they call for. In other words, approaches herein are able to efficiently provide answers to queries that cannot be directly answered using existing data.

This is achieved at least in part by using novel processes which involve question intent classification, question rephrasing, data selection, and iterative data selection under the direction of key driver analysis. For example, statistical tests, ontological understanding from data locations (e.g., column names, sample data, etc.), natural language insight generation, answer phrasing, and other evaluation tactics may be implemented to process a received query. However, this is also achieved without each of the AI models (e.g., LLM's) that are leveraged being trained on, or have access to, specific data (e.g., customer data) which is relevant to the received query, but which also may be considered private. In some approaches, only the SQL execution step can retrieve customer data, e.g., as will be described in further detail below.

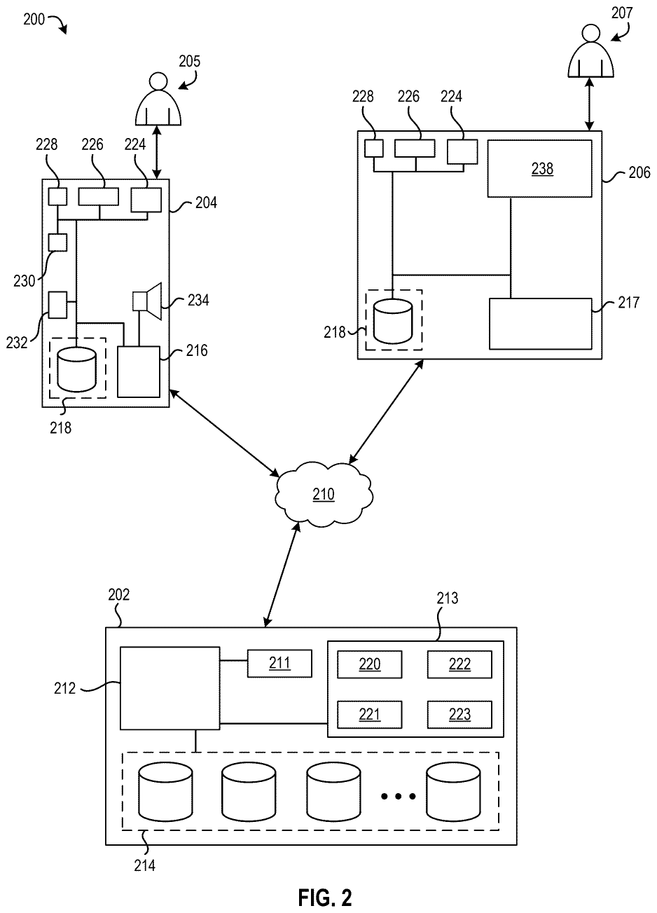

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central data storage location 202 that is connected to a user device 204, and edge node 206 that are accessible to the user 205 and administrator 207, respectively. The central data storage location 202, user device 204, and edge node 206 are each connected to a network 210, and may thereby be positioned in different geographical locations, in the same data center, or even in the same physical computing system. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, direct attached storage, an internal telephone network, etc. As a result, any desired information, data, commands, instructions, responses, requests, etc. may be sent between user device 204, edge node 206, and/or central data storage location 202, regardless of the amount of separation which exists therebetween, e.g., despite being positioned at different geographical locations. According to some approaches, the central data storage location 202 is a remote cloud server that is connected to (e.g., may be accessed by) user device 204 and/or edge node 206.

However, it should be noted that two or more of the user device 204, edge node 206, and central data storage location 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc. ; etc., or any other type of connection which would be apparent to one skilled in the art after reading the present description.

The terms “user,” and “administrator” are in no way intended to be limiting either. For instance, while users, and/or administrators may be described as being individuals in various implementations herein, a user, host, and/or administrator may be an application, an organization, a preset process, etc. The use of “data” and “information” herein are in no way intended to be limiting either, and may include any desired type of details, e.g., depending on the type of operating system implemented on the user device 204, edge node 206, and/or central data storage location 202. In some approaches, host write requests are received at the central data storage location 202 from a host (e.g., user 205 and/or administrator 207) at the user device 204 and/or the edge node 206, respectively. Accordingly, data may be written to memory at the central data storage location 202 in response to receiving host write requests, e.g., as would be appreciated by one skilled in the art after reading the present description.

With continued reference to FIG. 2, the central data storage location 202 includes a large (e.g., robust) processor 212 that is coupled to a cache 211, an AI module 213, a data storage array 214 having a relatively high storage capacity. The processor 212 and cache 211 are preferably configured to receive and process various requests, demands, instructions, commands, etc., involving data that may be stored in data storage array 214.

Additionally, the AI module 213 includes a number of components therein that may work together to evaluate each received query and preferably produce accurate answers thereto. Specifically, the AI module 213 includes a task classifier 220, a question rephraser 221, a key driver analyzer 222, and a final answer phraser 223. These components may be used individually and/or in combination to process a received user query. For instance, the task classifier 220 may be configured to accept natural language questions and decide what type of analysis is called for. In other words, the task classifier is preferably able to evaluate the query, and determine whether the natural language question should be evaluated using diagnostic analysis (e.g., for “why” based questions), driver analysis (e.g., for “what causes” questions), prescriptive analysis (e.g., for “how” based questions), and predictive analysis (e.g., for “what will happen” based questions). In still some approaches, the task classifier is able to identify received queries that are descriptive in nature, for which answers may be obtained through direct data lookup without performing any detailed analysis.

Moreover, the question rephraser 221 is preferably configured to rephrase an advanced natural language question into a standard selection query. Given the aforementioned limitations of text-to-SQL, most advanced analytics questions may not execute correctly, or may bring in superfluous data locations. In contrast the question rephraser 221 is able to accurately translate the advanced natural language question into one or more basic representations thereof. According to a non-limiting example, a query asking “why did revenue drop in August 2023 in Los Angeles” may be rephrased by the question rephraser 221 as “select revenue and Month, Year for July and August 2023 grouped by Month Year in Los Angeles”, and the task classifier 220 may further identify the standard selection query as having a diagnostic classification.

Advancing to the key driver analyzer 222, data locations (e.g., target column(s) and filter(s)) are used to perform the key driver analysis. This analysis is able to identify underlying data locations (e.g., column(s) and/or filter(s)) that statistically impact targeted data locations. In some approaches, the analysis may be performed at least in part based on ontology classifications of input data locations. In other approaches, random sample data of sufficient size for added statistical confidence and/or one or more of a suite of statistical tests may be implemented in order to perform the key driver analysis.

Furthermore, the final answer phraser 223 is preferably configured to generate natural language text that answers received queries. For instance, the final answer phraser 223 may utilize a task classification, the natural language original question, generated insights, etc., and/or other relevant information along with an LLM prompt to generate natural language text that answers a question. However, in some approaches the final answer phraser 223 points out any counterfactual or faulty premises that are present in the question that may prevent an accurate answer from being generated. For example, a query stating “why did revenue drop in August 2023” may be identified by the final answer phraser 223 as being counterfactual if revenue is determined as having actually increased in August 2023. Insights which are relevant to the received query will naturally be included in the answer as guided by relevant examples in the prompt based at least in part on the task type, e.g., as will be described in further detail below.

It follows that the AI module 213 may include any desired number and/or type of AI based models, e.g., such as machine learning models (e.g., large language models (LLMs)), deep learning models, neural networks, etc. In preferred approaches, the AI module 213 and/or processor 212 are able to train one or more AI based models to evaluate received queries and efficiently generate accurate answers thereto. Accordingly, approaches herein are able to automate the procedure of receiving and processing queries as much as possible by making use of multiple LLMs in addition to utilizing analysts to guide the decision-making process.

With continued reference to FIG. 2, the AI based models may be trained over time using characteristics (e.g., features) extracted from queries that are processed in real-time. However, one or more AI based models may be initially trained externally to the data storage location 202 (e.g., before being implemented therein) and AI module 213 may use characteristics gleaned from how various types of queries are ultimately handled to re-train the AI based model(s) over time. For example, characteristics collected from newly received queries may be inserted into one or more machine learning model(s) to calculate a classification score that is used to determine whether the query calls for a simple descriptive recitation of known information or a complex evaluation of known information to produce a unique answer. In some approaches, the AI based models are further configured to evaluate multiple queries in parallel. For instance, queries that have the same or similar lengths, categories, data locations, sources (e.g., originating user), etc. may be grouped together and evaluated in parallel. This desirably reduces latency and compute overhead associated with generating unique answers to a variety of different queries that may be received over a high traffic period.

The data storage array 214 may include any desired type of data storage components depending on the approach. Thus, while the data storage array 214 may be illustrated as including hard disk drives, this is in no way intended to be limiting. In other approaches, the array 214 may include solid state drives having volatile and/or non-volatile memory therein, magnetic tape drives, optical storage drives, etc. For instance, the central data storage location 202 may have a data storage module (not shown) including an array of storage devices. The array of storage devices may further include non-volatile memory that is used to store data, e.g., as would be appreciated by one skilled in the art after reading the present description.

Looking to the user device 204, it includes a processor 216 which is coupled to memory 218. The processor 216 receives inputs from, and interfaces with, user 205. For instance, the user 205 may input information and/or queries using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear. In some approaches, questions that call for processing of known information may be received from user device 204 for evaluation and processing using processor 212 and/or AI module 213 at central data storage location 202. The questions may be received as a result of the user 205 using one or more applications, software programs, temporary communication connections, etc. running on the user device 204.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. In some approaches, the edge node 206 is a server that may be running any desired type of application (e.g., database, web-server, etc.) which results in questions (e.g., complex queries) being sent to the central data storage location 202 and/or processed at the edge node 206 itself. As described above with respect to AI module 213, the AI module 238 may include any desired number and/or type of AI based models. It follows that AI module 238 may implement similar, the same, or different characteristics as AI module 213 in central data storage location 202, e.g., as would be appreciated by one skilled in the art after reading the present description.

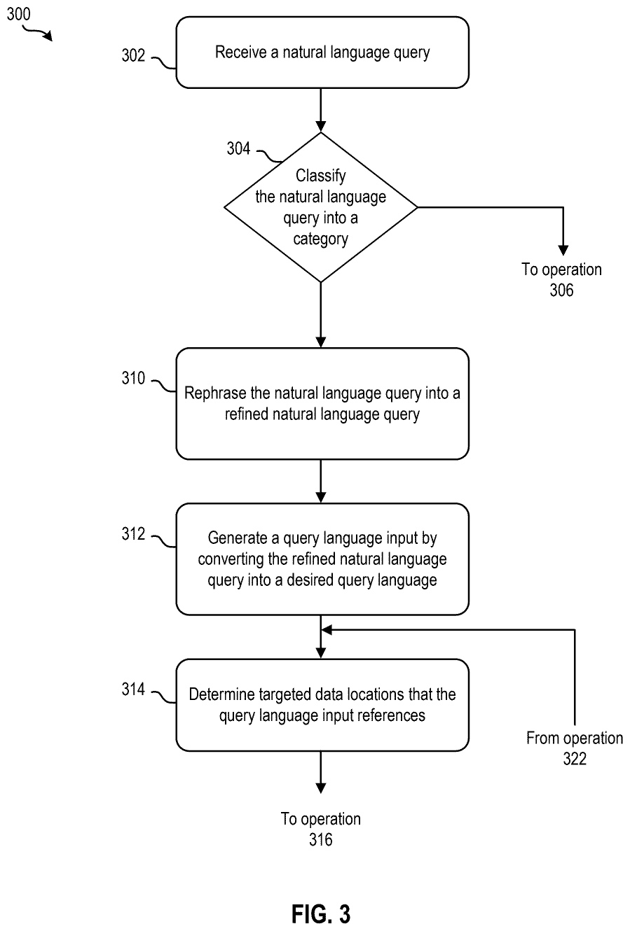

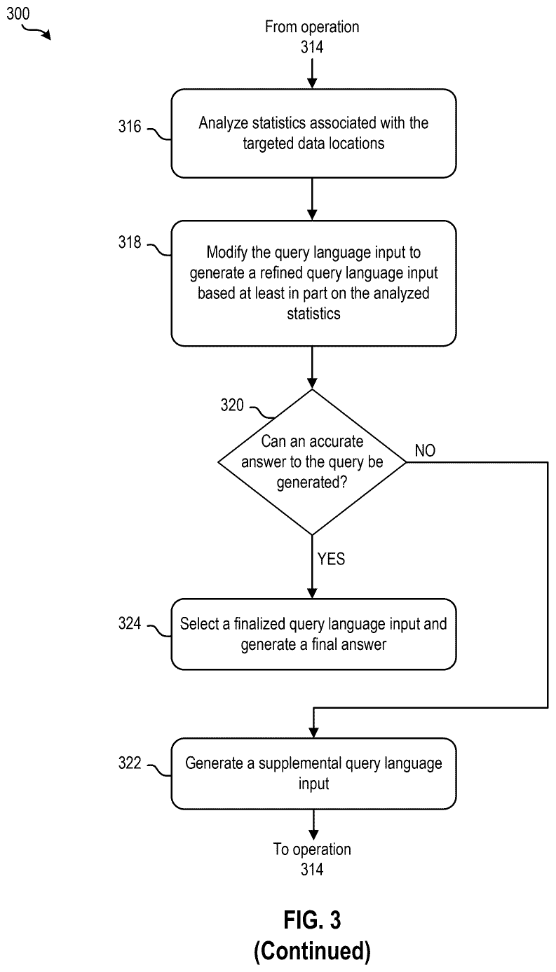

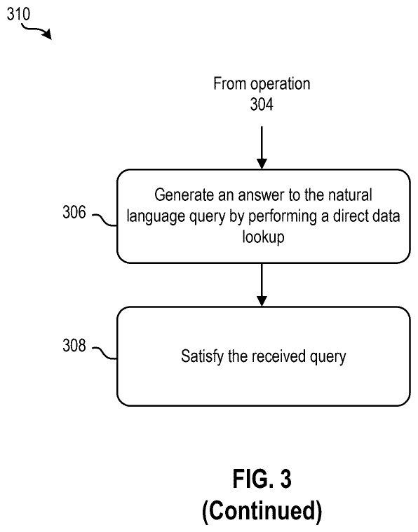

Looking now to FIG. 3, a flowchart of a computer-implemented method 300 for performing question decomposition of complex questions that go beyond the Text to SQL use-case is illustrated in accordance with one approach. The operations in method 300 may thereby be able to efficiently and accurately generate answers to questions that cannot be directly queried from any existing data. Approaches herein thereby have a significant impact on efficiency of the system overall, e.g., as will be described in further detail below.

Each of the steps of the method 300 may be performed by any suitable component of the operating environment using known techniques and/or techniques that would become readily apparent to one skilled in the art upon reading the present disclosure. For example, one or more processors and/or AI modules in servers of a distributed system (e.g., see processor 212 and/or AI module 213 of FIG. 2 above) may be used to perform one or more of the operations in method 300.

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving a natural language query. In other words, operation 302 includes receiving a query (also referred to herein as “question”) that requests information to be returned, and is in the form of a natural language prompt. As used herein, a “natural language” is intended to refer to any language that a user is versed in and able to phrase unique questions in. This typically includes human languages (e.g., English, Spanish, French, etc.), but may include other types of languages in some approaches. For example, a query may be received in the form of a computer language (e.g., programming language, operating code, etc.) from a running application.

From operation 302, method 300 advances to operation 304. There, operation 304 includes classifying the natural language query into a category. In other words, operation 304 includes inspecting the natural language question and determining what type of analysis should be performed. As noted above, queries may be evaluated and/or classified using a task classifier (e.g., see task classifier 220 of FIG. 2). The task classifier may be configured to accept the natural language question and decides what type of analysis will be implemented to generate a response. In some approaches, the received question may be classified into a finite number of categories. Thus, a task classifier may select one or more categories from a set list of available options that is/are determined as corresponding to the received question. According to a non-limiting example, the categories are selected from the group consisting of: diagnostic, driver, prescriptive, predictive, and descriptive. It follows that in response to evaluating the question, the task classifier may determine that the question is diagnostic (e.g., why questions), driver (e.g., what causes questions), prescriptive (e.g., how does questions), predictive (e.g., what will happen questions), and/or descriptive (e.g., asking to reproduce known information).

In situations where the natural language query is determined as being descriptive in nature, the answer may be obtained through direct data lookup without performing any advanced analysis of the data. Accordingly, method 300 advances from operation 304 to operation 306 in response to determining the natural language query has been classified into the descriptive category. There, operation 306 includes generating an answer to the natural language query by performing a direct data lookup. In other words, queries that simply call for existing (e.g., known) information to be reproduced may be satisfied without running various evaluations and consuming an unnecessary amount of system resources, e.g., such as compute throughput. Method 300 further advances to operation 308 where the answer generated for the descriptive query is transferred to the source of the query. In other words, operation 308 includes satisfying the query received in operation 302.

However, returning to operation 304, method 300 advances to operation 310 in response to determining that the natural language query is not descriptive. In other words, method 300 advances to operation 310 in response to determining the natural language query has been classified into one or more of the diagnostic, driver, prescriptive, and/or predictive categories. There, operation 310 includes rephrasing the natural language query into a refined natural language query. This rephrasing of the natural language query allows for the initial query to be converted into a query language. Natural language queries may be rephrased using a task specific query rephraser.

Given the limitations of text-to-SQL, most advanced analytics questions that are received by conventional products are unable to be executed correctly and/or may bring in superfluous data. However, by rephrasing the query such that each of the different parts thereof are fully considered and evaluated individually as well as a whole to gain an accurate understanding of what is being asked. According to a non-limiting example, a natural language query that is received may ask “why did revenue drop in August 2023 in Los Angeles.” This example query may thereby be classified as being diagnostic, and rephrased as “select revenue and month, year for July and August 2023 grouped by month year in Los Angeles.”

Proceeding from operation 310, method 300 advances to operation 312. There, operation 312 includes generating a query language input by converting the refined natural language query into a desired query language. In other words, the refined natural language query formed in operation 310 is preferably converted again into a desired query language. According to some approaches, operation 312 may include converting the refined natural language query from a human language to one or more computer languages. This may allow for the query (originally entered by a user) to be converted into a form that AI based models are able to evaluate and generate answers to.

Operation 314 further includes determining targeted data locations that the query language input references. Depending on the approach, data may be configured differently and therefore the targeted data locations may vary. In some approaches, data locations may be identified by target tables, columns and/or rows, filters, etc., and/or combinations thereof. Operation 314 thereby effectively takes the rephased question and executes the query, returning not just the data, but also the separation of selected data locations (e.g., target columns, filters, etc.). According to another non-limiting example, the question “why did revenue drop in August 2023 in Los Angeles” may be converted into a desired query language and evaluated, ultimately outputting that the query targets (e.g., involves) the select location “Sales. Revenue”, with filters “Sales. Month” and “Sales. Year” along with “Store. City” also being of interest. It follows that operation 314 may at least partially convert the refined natural language queries into SQL.

From operation 314, method 300 advances to operation 316. There, operation 316 includes analyzing statistics associated with the targeted data locations. In other words, operation 316 includes evaluating the various data locations identified in operation 314 and determining whether they are statistically impacted by any other data locations. Operation 314 thereby includes identifying underlying data locations that statistically impact the targeted data locations. These underlying data locations may be identified in some approaches by performing an ontological classification of at least a majority (preferably all) of the data locations. This provides an accurate view of what other data locations have at least some impact on the target data locations (tied to the initial query).

Following the example introduced above, given the target column(s) and filter(s) of data, key driver analysis may be performed on the target locations (and/or other data locations) to determine underlying columns that statistically impact the target column(s). This key driver analysis may be performed by implementing ontology classification of the input columns. The key driver analysis performed in operation 316 may also be performed on a random sample data of a sufficient size to achieve statistical confidence at a desired level. It follows that any one or more statistical tests may be performed on the target data locations and/or other data locations to determine interrelationships therebetween. In preferred approaches, one or more AI based models may be trained to evaluate the various data locations and identify patterns that track the “key drivers” which have an impact on targets.

With continued reference to FIG. 3, method 300 advances from operation 316 to operation 318. There, operation 318 includes modifying the query language input to generate a refined query language input based at least in part on the analyzed statistics.

In other words, operation 318 includes applying the information acquired in operation 316 to actively generate insight. According to a non-limiting example, given the initial data retrieved from operation 314 above, and the key driver analysis from operation 316 above, one or more key driver columns may be added to a selection SQL statement. Moreover, filters from the context of the originally received query and/or execute SQL on customer data may be used to further evaluate the data locations. Given the resulting data, highs, lows, averages, deltas, etc., and/or combinations thereof may be determined between desired time periods. In some approaches, insights are generated from templated text.

From operation 318, method 300 advances to operation 320. There, operation 320 includes performing a depth limit check. In other words, operation 320 includes determining whether a sufficiently accurate answer may be generated for the initial natural language query that was received. In some approaches, the “accuracy” of an answer may be determined at least in part by using LLM(s) that are trained to systematically check if a generated answer has the same or similar topics as the initial query. Operation 320 effectively prevents method 300 from performing an infinite search for an answer to the initial query. In some approaches, operation 320 includes determining how many times various operations in method 300 have been performed.

In response to determining an answer may not be derived from the analyzed statistics, method 300 advances from operation 320 to operation 322. There, operation 322 includes generating a supplemental query language input. In other words, because a sufficiently accurate answer cannot yet be generated, additional analysis is preferably performed. The refined natural language query is re-converted into the same query language in some approaches. However, the refined natural language query may be converted into a different query language in other approaches. In other words, by converting the refined natural language query differently than before, operation 322 introduces a new query language input. This new query language input may further be evaluated and/or processed using one or more of the above operations. Targeted data locations that the supplemental query language input references is thereby determined. Additionally, statistics associated with supplemental data locations that are targeted by the supplemental query language input are preferably analyzed. Accordingly, method 300 is shown as returning to operation 314 from operation 322.

Returning now to operation 320, method proceeds to operation 324 in response to determining that an answer may be derived from the analyzed statistics. In other words, method advances to operation 324 in response to determining a sufficiently accurate answer to a question asking for something that may not be derived by simply fetching desired data. There, operation 324 includes selecting a finalized query language input and generating a final answer to the refined query language input. In other words, operation 324 includes evaluating all of the insights gained by performing operations 302-322 to finalize the query, and generate a final answer. The finalized query language input may be selected based at least in part on the performance analysis of: the refined query language input and/or the newly refined query language inputs. In other words, operation 324 selects the finalized query language input based on insight gained from each iteration of operation 322.

Insights which are relevant to a received query (e.g., why did revenue drop) will naturally be included in the answer as guided by relevant examples in the prompt, based on the task type. According to some approaches, given the task classification, the natural language original question, and the generated insights, an LLM prompt may be used to generate natural language text that answers the initially received query. The LLM may also be able to identify false queries by flagging counterfactual and/or faulty premise(s) of the query that was received. For example, the query “why did revenue drop in August 2023” may be counterfactual if revenue actually increased in August 2023.

It follows that the operations of method 300 are able to perform question decomposition for questions that go beyond the Text to SQL use-case. Approaches herein are thereby able to process received queries regardless of the level of abstraction they call for. In other words, approaches herein are able to efficiently provide answers to queries that cannot be directly answered using existing data.

This is achieved at least in part by using novel processes which involve question intent classification, question rephrasing, data selection, and iterative data selection under the direction of key driver analysis. For example, statistical tests, ontological understanding from data locations (e.g., column names, sample data, etc.), natural language insight generation, answer phrasing, and other evaluation tactics may be implemented to process a received query. However, this is also achieved without each of the AI models (e.g., LLM's) that are leveraged being trained on, or have access to, specific data (e.g., customer data) which is relevant to the received query, but which also may be considered private. In some approaches, only the SQL execution step can retrieve customer data.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

1. A method comprising:
receiving a natural language query;
classifying the natural language query into a category;
rephrasing the natural language query into a refined natural language query;
generating a query language input by converting the refined natural language query into a query language;
determining targeted data locations that the query language input references;
analyzing statistics associated with the targeted data locations; and
modifying the query language input to generate a refined query language input based at least in part on the analyzed statistics comprising adding one or more driver columns to a selection query language statement and applying filters from context associated with an originally received query to further evaluate the targeted data locations.

2. The method of claim 1, further comprising:
analyzing performance of the refined query language input.

3. The method of claim 2, further comprising:
generating a plurality of newly refined query language inputs;
analyzing performance of the newly refined query language inputs; and
selecting a finalized query language input based at least in part on the performance analysis of: the refined query language input, and the newly refined query language inputs.

4. The method of claim 1, wherein analyzing statistics associated with the targeted data locations includes:
identifying underlying data locations that statistically impact the targeted data locations.

5. The method of claim 4, wherein the identifying underlying data locations that statistically impact the targeted data locations includes: performing an ontological classification of at least a majority of data locations.

6. The method of claim 1, further comprising:
performing a depth limit check;
in response to determining an answer may be derived from the analyzed statistics, modifying the query language input to generate the refined query language input; and
generating a final answer to the refined query language input.

7. The method of claim 6, further comprising:
in response to determining an answer may not be derived from the analyzed statistics:
generating a supplemental query language input by converting the refined natural language query into the query language; and
analyzing statistics associated with supplemental data locations that are targeted by the supplemental query language input.

8. The method of claim 1, wherein the categories are selected from the group consisting of: diagnostic, driver, prescriptive, predictive, and descriptive.

9. The method of claim 8, further comprising:
in response to determining the natural language query has been classified into one or more of the diagnostic, driver, prescriptive, and/or predictive categories, rephrasing the natural language query into the refined natural language query.

10. The method of claim 8, further comprising:
in response to determining the natural language query has been classified into the descriptive category, generating an answer to the natural language query by performing a direct data lookup.

11. A computer program product comprising:
one or more computer-readable storage media; and
program instructions stored on the one or more storage media to perform operations comprising:
receiving a natural language query;
classifying the natural language query into a category;
rephrasing the natural language query into a refined natural language query;
generating a query language input by converting the refined natural language query into a query language;
determining targeted data locations that the query language input references;
analyzing statistics associated with the targeted data locations; and
modifying the query language input to generate a refined query language input based at least in part on the analyzed statistics comprising adding one or more driver columns to a selection query language statement and applying filters from context associated with an originally received query to further evaluate the targeted data locations.

12. The computer program product of claim 11, wherein the operations further comprise:
analyzing performance of the refined query language input;
generating a plurality of newly refined query language inputs;
analyzing performance of the newly refined query language inputs; and
selecting a finalized query language input based at least in part on the performance analysis of: the refined query language input, and the newly refined query language inputs.

13. The computer program product of claim 11, wherein the analyzing statistics associated with the targeted data locations includes:
identifying underlying data locations that statistically impact the targeted data locations.

14. The computer program product of claim 13, wherein the identifying underlying data locations that statistically impact the targeted data locations includes:
performing an ontological classification of at least a majority of data locations.

15. The computer program product of claim 11, wherein the operations further comprise:
performing a depth limit check;
in response to determining an answer may be derived from the analyzed statistics, modifying the query language input to generate the refined query language input; and
generating a final answer to the refined query language input.

16. The computer program product of claim 15, wherein the operations further comprise:
in response to determining an answer may not be derived from the analyzed statistics:
generating a supplemental query language input by converting the refined natural language query into the query language; and
analyzing statistics associated with supplemental data locations that are targeted by the supplemental query language input.

17. The computer program product of claim 11, wherein the categories are selected from the group consisting of: diagnostic, driver, prescriptive, predictive, and descriptive.

18. The computer program product of claim 17, wherein the operations further comprise:
in response to determining the natural language query has been classified into one or more of the diagnostic, driver, prescriptive, and/or predictive categories, rephrasing the natural language query into the refined natural language query.

19. The computer program product of claim 17, wherein the operations further comprise:
in response to determining the natural language query has been classified into the descriptive category, generating an answer to the natural language query by performing a direct data lookup.

20. A computer system comprising:
a processor set;
one or more computer-readable storage media; and
program instructions stored on the one or more storage media to cause the processor set to perform operations comprising:
receiving a natural language query;
classifying the natural language query into a category;
rephrasing the natural language query into a refined natural language query;
generating a query language input by converting the refined natural language query into a query language;
determining targeted data locations that the query language input references;
analyzing statistics associated with the targeted data locations; and
modifying the query language input to generate a refined query language input based at least in part on the analyzed statistics comprising adding one or more driver columns to a selection query language statement and applying filters from context associated with an originally received query to further evaluate the targeted data locations.
